(19) United States
(12) Patent Application Publication
(10) Pub. No.: US 2011/0158568 A1
(43) Pub. Date: Jun. 30, 2011

(54) SNAP-ON FAN SHAFT SEAT

(76) Inventor: Mingju Chen, Sinjhuang City (TW)

(21) Appl. No.: 12/647,723

(22) Filed: Dec. 28, 2009

(51) Int. Cl. F16C 35/02

(52) U.S. Cl. 384/428

(57) ABSTRACT

A snap-on fan shaft seat including a shaft bushing and a bed section. The shaft bushing has a first open end and a second open end opposite to the first open end. The shaft bushing defines an internal receiving space. Outer circumference of the shaft bushing is formed with a restriction neck section in adjacent to the second open end. At least one recess is formed on the restriction neck section. The bed section has a shaft hole for fitting the restriction neck section of the shaft bushing therein. The bed section further has at least one engaging section disposed on a wall of the shaft hole corresponding to the recess, whereby the engaging section can be fixedly engaged in the recess. The shaft bushing and the bed section can be quickly firmly assembled to shorten working time and facilitate assembling process so as to lower the manufacturing cost.

### FIELD OF THE INVENTION

The present invention relates to a snap-on fan shaft seat including a shaft bushing and a bed section. The shaft bushing and the bed section can be quickly assembled to increase structural strength, shorten working time and facilitate assembling process so as to lower the manufacturing cost.

### BACKGROUND OF THE INVENTION

Recently, the internal circuits of the integrated circuit (IC) chip have been laid out more and more compactly. Consequently, the chip generates higher and higher heat. When a personal computer works, the compact IC chip such as CPU or graphics chip will generate high heat. In order to keep the IC chip functioning lastingly, it is necessary to maintain the IC chip at an optimal working temperature. In this case, rise of temperature can be avoided so as not to deteriorate the efficiency of the IC chip or damage the IC chip. In general, a heat dissipation device is used to directly contact the surface of the electronic component for dissipating the heat generated by the electronic component. Accordingly, the electronic component can keep working normally without shortening its lifetime.

A cooling fan is an inevitable component of a heat dissipation device. The cooling fan is able to quickly carry away the heat absorbed by a radiating fin assembly to complete a thermal cycle and achieve better heat dissipation effect.

FIG. 1 shows a conventional cooling fan, which includes a fan propeller 10, a motor assembly 11, a shaft bushing 12 and a bed 13. The fan propeller 10 has a shaft 101. A first end of the shaft 101 is insert-connected with the fan propeller 10, while a second end of the shaft 101 is received in the shaft bushing 12. That is, the shaft 101 is rotatably connected with the shaft bushing 12. The shaft bushing 12 is made of magnetically permeable material and has an internal receiving space 121 for accommodating the shaft 101 of the fan propeller 10. A first end of the shaft bushing 12 in proximity to the fan propeller 10 is formed with an abutment section 123. The abutment section 123 outward extends from the first end of the shaft bushing 12 in a direction away from a center of the receiving space 121. The abutment section 123 serves to abut against the motor assembly 11 to fix the same. A second end of the shaft bushing 12 distal from the fan propeller 10 is formed with a support section 124. The support section 124 inward extends from the second end of the shaft bushing 12 in a direction to the center of the receiving space 121. A wear plate 15 is positioned on the support section 124 between the shaft 101 and the support section 124. The second end of the shaft 101 is leant against a surface of the wear plate 15. An outer circumference of the second end of the shaft bushing 12 is fixedly adhered to the bed 13.

Conventionally, the shaft bushing 12 is fixedly connected to the bed 13 with an adhesive. When applying the adhesive to the outer circumference of the second end of the shaft bushing 12 and the bed 13, it is hard for an operator to control the amount of the adhesive. This often results in damage of the fan in operation or transfer. For example, in case the amount of the adhesive applied to the shaft bushing 12 and the bed 13 is insufficient or the valid period of the adhesive expires, the shaft bushing 12 tends to loosen from the bed 13 due to vibration or shake in operation or transfer. In some serious cases, some parts of the fan may fly away to hit other peripheral electronic components due to centrifugal force.

On the other hand, in case excessive adhesive is applied to the shaft bushing 12 and the bed 13, the adhesive may spill out to stain other parts of the fan. This will lead to poor appearance of the fan. Moreover, in assembling process, it is necessary to apply the adhesive to the shaft bushing 12 and the bed 13 for fixing them with each other. This step is troublesome and results in increase of working time. Therefore, the manufacturing cost is relatively high.

Furthermore, after the adhesive is applied to the bed 13 and the shaft bushing 12, an operator needs to forcedly fit the bed 13 onto the second end of the shaft bushing 12 to adhere the bed 13 to the shaft bushing 12. In such process, it is hard for the operator to exert uniform force onto the bed 13. As a result, it often takes place that the horizontality of the bed 13 or the verticality of the shaft bushing 12 is deteriorated. Consequently, the fan will vibrate or make a noise in operation. According to the above, the conventional technique has the following defects:

1. The manufacturing cost is higher.
2. The working time is longer.
3. The assembling process is troublesome.
4. The structural strength is poor.

### SUMMARY OF THE INVENTION

A primary object of the present invention is to provide a snap-on fan shaft seat including a shaft bushing and a bed section. The shaft bushing and the bed section can be quickly assembled to lower manufacturing cost.

A further object of the present invention is to provide the above snap-on fan shaft seat in which the shaft bushing and the bed section can be quickly assembled to shorten working time and facilitate assembling process.

A still further object of the present invention is to provide the above snap-on fan shaft seat in which the shaft bushing has a recess, while the bed section has an engaging section corresponding to the recess. The shaft bushing can be connected with the bed section with the engaging section securely engaged in the recess. Accordingly, the shaft bushing is prevented from loosening from the bed section and the structural strength is increased.

To achieve the above and other objects, the snap-on fan shaft seat of the present invention includes a shaft bushing and a bed section. The shaft bushing has a first open end and a second open end opposite to the first open end. The shaft bushing defines an internal receiving space. Outer circumference of the shaft bushing is formed with a restriction neck section in adjacent to the second open end. At least one recess is formed on the restriction neck section. The bed section has a shaft hole for fitting the restriction neck section of the shaft bushing therein. The bed section further has at least one engaging section disposed on a wall of the shaft hole corresponding to the recess, whereby the engaging section can be fixedly engaged in the recess. The shaft bushing and the bed section can be quickly firmly assembled to increase structural strength, shorten working time and facilitate assembling process so as to lower the manufacturing cost.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a sectional assembled view of a conventional cooling fan;

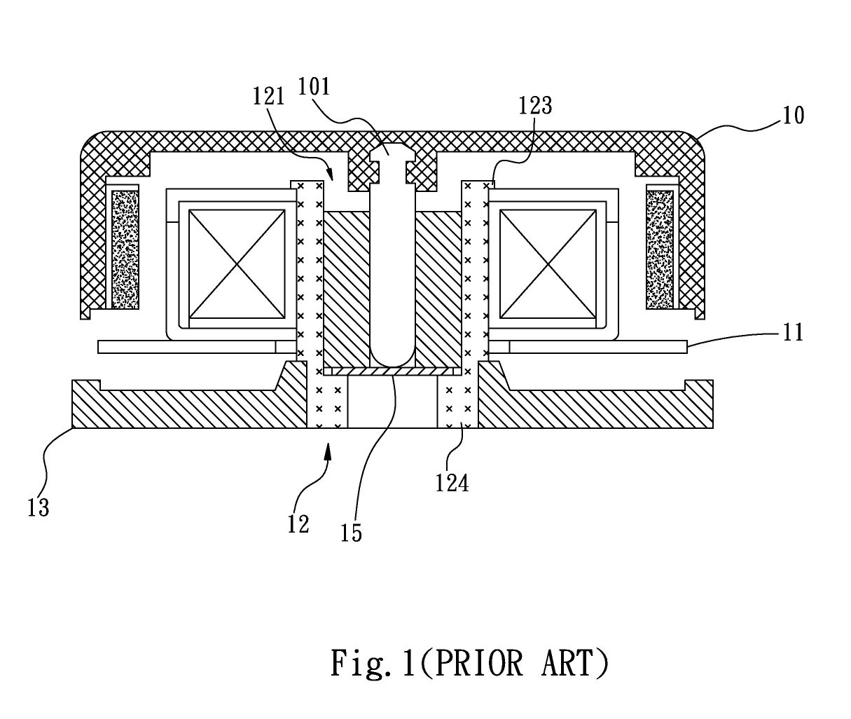

FIG. 2 is a sectional exploded view of a preferred embodiment of the present invention; and

FIG. 3 is a sectional assembled view of the preferred embodiment of the present invention.

### DETAILED DESCRIPTION OF THE PREFERRED EMBODIMENT

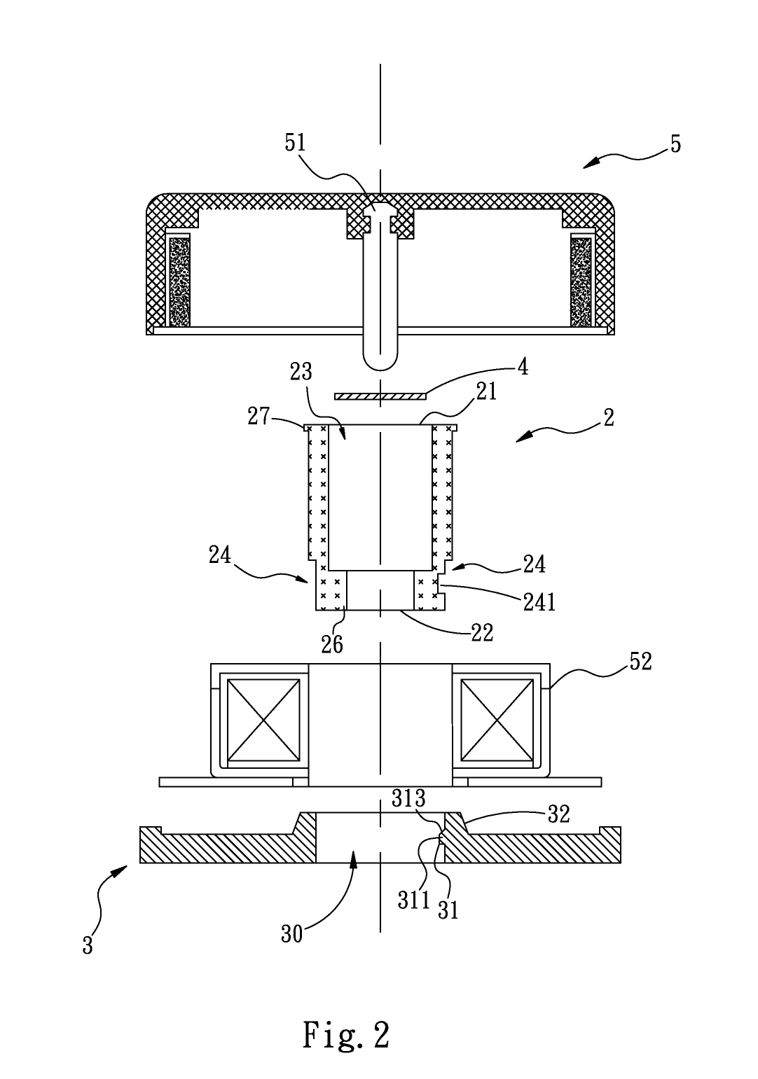

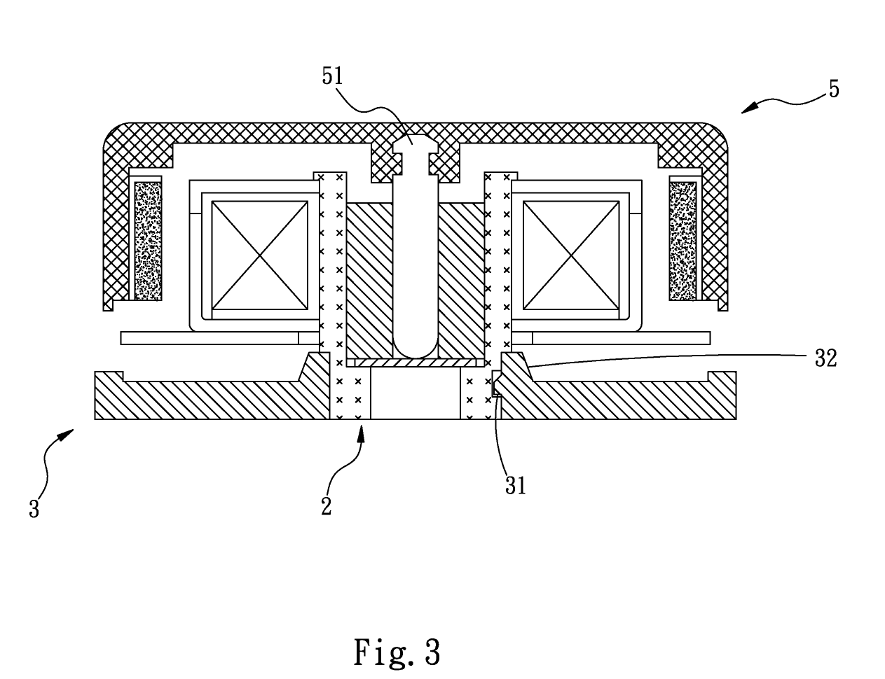

Please refer to FIGS. 2 and 3. According to a preferred embodiment, the snap-on fan shaft seat of the present invention includes a shaft bushing 2 and a bed section 3. The shaft bushing 12 is made of magnetically permeable material such as iron and ferroalloys. The shaft bushing 12 has a first open end 21 and a second open end 22 opposite to the first open end 21. The shaft bushing 12 defines an internal receiving space 23. An outer circumference of the shaft bushing 2 is formed with a restriction neck section 24 in adjacent to the second open end 22. In other words, the restriction neck section 24 is formed on the outer circumference of the shaft bushing 2 in adjacency to the second open end 22 distal from the first open end 21 of the shaft bushing 2. At least one recess 241 is formed on the restriction neck section 24. As shown in FIG. 3, the restriction neck section 24 and the recess 241 are formed on the outer circumference of the shaft bushing 2 in a stepped form.

The bed section 3 has a shaft hole 30 for fitting the restriction neck section 24 of the shaft bushing 2 therein. The bed section 3 has at least one engaging section 31 disposed on a wall of the shaft hole 30 corresponding to the recess 241. The engaging section 31 can be fixedly engaged in the recess 241. That is, the bed section 3 can be fitted onto the second open end 22 of the shaft bushing 2 to make one end of the shaft hole 30 pass through one end of the restriction neck section 24 in adjacency to the second open end 22 of the shaft bushing 2. The bed section 3 is further moved toward a shoulder section of the restriction neck section 24 until an end of the bed section 3 tightly abuts against the shoulder section. At this time, the engaging section 31 is fixedly engaged in the recess 241 with the restriction neck section 24 enclosed in the shaft hole 30.

By means of the engagement between the engaging section 31 of the bed section 3 and the restriction neck section 24 of the shaft bushing 2, the shaft bushing 2 is restricted from longitudinally moving (or shaking) during operation of the fan. Also, after assembled, the shaft bushing 2 is restricted from left or right rotating (or shaking) during operation. Therefore, the shaft bushing 2 is prevented from loosening from the bed section 3 and the structural strength is enhanced as a whole. The outer diameter of the restriction neck section 24 of the shaft bushing 2 is equal to the inner diameter of the shaft hole 30 of the bed section 3.

Please refer to FIGS. 2 and 3. The shaft bushing 2 is further formed with a support section 26 in adjacency to the second open end 22. The support section 26 extends from inner circumference of the restriction neck section 24 toward the center of the receiving space 23. A wear plate 4 is positioned on a first end of the support section 26. A second end of the support section 26 is flush with the second open end 22. A fan propeller 5 is fitted in the shaft bushing 2. The fan propeller 5 includes a shaft 51 and a motor assembly 52. A first end of the shaft 51 is insert-connected with the fan propeller 5. A second end of the shaft 51 is received in the receiving space 23 of the shaft bushing 2 in contact with a surface of the wear plate 4. The wear plate 4 is positioned between the support section 26 and the shaft 51.

The shaft bushing 2 further has a stop section 27 outward extending from the first open end 21 of the shaft bushing 12 to abut against and fix the motor assembly 52. The bed section 3 is formed with a raised section 32 protruding from the end of the bed section 3 around the shaft hole 30. The raised section 32 abuts against the shoulder section of the restriction neck section 24. In other words, the raised section 32 protrudes from inner circumference of the bed section 3 around the shaft hole 30 in abutment with the shoulder section of the restriction neck section 24 for supporting and fixing the shaft bushing 2.

Preferably, the engaging section 31 is a protrusion 311 protruding from the inner circumference of the bed section 3. The protrusion 311 has a slide slope 313 obliquely extending from a first side of the protrusion 311 to a second side thereof to facilitate assembling process. The protrusion 311 has a size adapted to the size of the recess 241.

Please refer to FIGS. 2 and 3. When assembling the fan, the motor assembly 52 is moved toward the second open end 22 of the shaft bushing 2 and fitted around the shaft bushing 2 until one end of the motor assembly 52 abuts against the stop section of the shaft bushing 2. Then the raised section 32 of the bed section 3 is forced toward the restriction neck section 24 of the shaft bushing 2 to make the end of the shaft hole 30 pass through the end of the restriction neck section 24. When the slide slope 313 of the protrusion 311 touches the end of the restriction neck section 24, the end of the restriction neck section 24 will slide along the slide slope 313.

Also, during the movement, the raised section 32 of the bed section 3 is temporarily deformed due to external force. The bed section 3 is further moved toward the shoulder section of the restriction neck section 24 until the top of the raised section 32 abuts against the shoulder section. At this time, the protrusion 311 is fixedly engaged in the recess 241. Then the wear plate 4 is placed into the receiving space 23 onto the support section 26. Finally, the shaft 51 of the fan propeller 5 is fitted into the receiving space 23 into contact with the surface of the wear plate 4. The raised section 32 is fixedly fitted on the restriction neck section 24. Therefore, in operation or transfer of the fan, the shaft bushing 2 is prevented from longitudinally displacing. Moreover, the protrusion 311 of the engaging section 31 is engaged in the recess 241 of the restriction neck section 24 to prevent the shaft bushing 2 from rotating left or right. Accordingly, the shaft bushing is prevented from loosening from the bed section 3 and the structural strength is increased as a whole.

The shaft bushing 2 and the bed section 3 can be quickly fixedly assembled without using any adhesive material (such as glue). Therefore, the working time is shortened and the assembling process is facilitated to lower the manufacturing cost.

According to the aforesaid, the snap-on fan shaft seat of the present invention has the following advantages:

1. The manufacturing cost is lowered.
2. The working time is shortened.
3. The assembling process is facilitated.
4. The structural strength is increased.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A snap-on fan shaft seat comprising:
a shaft bushing having a first open end and a second open end opposite to the first open end, the shaft bushing defining an internal receiving space, outer circumference of the shaft bushing being formed with a restriction neck section in adjacent to the second open end, at least one recess being formed on the restriction neck section; and
a bed section having a shaft hole for fitting the restriction neck section of the shaft bushing therein, the bed section having at least one engaging section disposed on a wall of the shaft hole corresponding to the recess, whereby the engaging section can be fixedly engaged in the recess.

2. The snap-on fan shaft seat as claimed in claim 1, wherein the restriction neck section and the recess are formed on the outer circumference of the shaft bushing in a stepped form.

3. The snap-on fan shaft seat as claimed in claim 1, wherein the shaft bushing is further formed with a support section extending from inner circumference of the restriction neck section toward a center of the receiving space, a wear plate being positioned on a first end of the support section, a second end of the support section being flush with the second open end.

4. The snap-on fan shaft seat as claimed in claim 3, wherein a fan propeller is fitted in the shaft bushing, the fan propeller including a shaft and a motor assembly, a first end of the shaft being insert-connected with the fan propeller, a second end of the shaft being received in the receiving space of the shaft bushing in contact with a surface of the wear plate.

5. The snap-on fan shaft seat as claimed in claim 4, wherein the shaft bushing further has a stop section outward extending from the first open end of the shaft bushing to abut against and fix the motor assembly.

6. The snap-on fan shaft seat as claimed in claim 1, wherein the bed section is further formed with a raised section protruding from an end of the bed section around the shaft hole, the raised section abutting against a shoulder section of the restriction neck section for supporting and fixing the shaft bushing.

7. The snap-on fan shaft seat as claimed in claim 1, wherein the restriction neck section of the shaft bushing has an outer diameter equal to inner diameter of the shaft hole of the bed section.

8. The snap-on fan shaft seat as claimed in claim 1, wherein the engaging section is a protrusion protruding from the inner circumference of the bed section, the protrusion having a slide slope obliquely extending from a first side of the protrusion to a second side thereof.

9. The snap-on fan shaft seat as claimed in claim 8, wherein the protrusion has a size adapted to the size of the recess.

10. The snap-on fan shaft seat as claimed in claim 1, wherein the shaft bushing is made of magnetically permeable material.
